(19) United States
(12) Patent Application Publication
(10) Pub. No.: US 2006/0110631 A1
(43) Pub. Date: May 25, 2006

(54) Catalyst ink, process for making catalyst ink and for preparing catalyst coated membranes

(75) Inventors: David L. Olmeijer, San Francisco, CA (US); Christopher G. Castledine, Mountain View, CA (US); Jonathan D. Servaites, Oakland, CA (US); Douglas S. Diez, Union City, CA (US)

Correspondence Address: DORSEY & WHITNEY LLP, 555 CALIFORNIA STREET, SUITE 1000, SUITE 1000, SAN FRANCISCO, CA, 94104, US

(73) Assignee: Polyfuel, Inc.

(21) Appl. No.: 11/061,331

(22) Filed: Feb. 18, 2005

Related U.S. Application Data
(60) Provisional application No. 60/546,078, filed on Feb. 18, 2004.

(51) Int. Cl. H01M 8/00

(52) U.S. Cl. 429/12

(57) ABSTRACT

The invention relates to catalyst inks used in the formation of catalyst coated membranes used in fuel cells.

This application claims benefit under 35 U.S.C. §119(e) to U.S. Ser. No. 60/546,078, filed Feb. 18, 2005 which is incorporated herein by reference in its entirety.

### FIELD OF THE INVENTION

The invention relates to catalyst inks used in the formation of catalyst coated membranes used in fuel cells.

### BACKGROUND OF THE INVENTION

Nafion® is a common commercial ionomer used in fuel cell applications. It is a sulfonated perflorinated polymer which functions as a polymer electrolyte membrane (PEM). In a fuel cell, the PEM is typically coated with anode and cathode catalyst layers which promote chemical reactions which results in the oxidation of a fuel on the anode surface, transport of a proton across the PEM and reduction of oxygen at the cathode surface. In the process, electrons are conducted form the anode through a load and then to the cathode to complete the reduction of oxygen to water.

There are many components which influence the overall performance of a fuel cell. An important component is the catalyst layer and the junction between it and the PEM.

In the past, catalyst layers have been applied to Nafion® and other PEMs by applying a suspension of metal catalysts such as platinum or platinum/ruthenium, typically supported on carbon particles, and Nafion® ionomer suspended in an aqueous solution or water/alcohol solution. This results in a catalyst coated membrane which can be used in a fuel cell such as a direct methanol fuel cell (DMFC).

A significant problem with such catalyst coated membranes is the swelling of the ionomer and membranes when in contact with fuels such as methanol. This results in a weakening of the interface between the catalyst layer and the membrane. In addition, when PEMs other than Nafion® membranes are used, Nafion® is often not compatible with such PEMs resulting in less than optimal adherence between the catalyst layer and the membrane and interfacial resistance at the catalyst layer/membrane junction.

### SUMMARY OF THE INVENTION

In one aspect, the invention relates to a catalyst ink comprising a metal catalyst, an ionomer and one or more non-aqueous solvents which together comprise at least 50% of the liquid in said catalyst ink.

In general, the non-aqueous solvents taken together with any other component in the liquid portion of the catalyst will have a dielectric constant of approximately 5 or greater, more preferably 15 or greater and most preferably 30 or greater. Individual non-aqueous solvents also preferably have the aforementioned dielectric constants. Some non-aqueous solvents may have a dielectric constant which is less than the preferred dielectric constant. However, when combined with one or more other non-aqueous solvents the resultant liquid will have the preferred dielectric constant.

Examples of non-aqueous solvent(s) include alcohols, glycols, alkyl ethers, alkyl ketones, alkyl esters, alkyl amides, alkyl sulfones, alkyl sulfoxides and alkyl carbonates. The alkyl groups may be linear, branched or cyclic and may be substituted. Such alkyl groups generally have between 1 and 10 carbon atoms. The non-aqueous solvent(s) generally has a boiling point between 80 and 250 degrees Celsius. In preferred embodiments, the non-aqueous solvent is dimethylacetamide (DMAc), dimethylformamide (DMF), N-methylpyrrolidone, propylene carbonate, dimethyl sulfoxide, tetramethylene sulfone, cyclohexanone, cyclopentanone, 2-butoxy ethanol, 2-methoxy ethanol, ethylene glycol, 1,2 propanediol, isopropyl alcohol, glycerol, 1-octanol, butanol, 2-methoxyethyl ether, and/or methyl propyl ketone.

DMAc may be combined with one or more of dimethylformamide (DMF), N-methylpyrrolidone, propylene carbonate, dimethyl sulfoxide, tetramethylene sulfone, cyclohexanone, cyclopentanone, 2-butoxy ethanol, 2-methoxy ethanol, ethylene glycol, 1,2 propanediol, isopropyl alcohol, glycerol, 1-octanol, butanol, 2-methoxyethyl ether, and/or methyl propyl ketone.

In an alternate embodiment, the catalyst ink can include a conductive filler such as graphite particles, carbon particles or graphitized carbon particles.

The invention also includes a process for making the catalyst ink which comprises mixing the ionomer, metal catalyst and one or non-aqueous solvent(s) to form a catalytic ink. The ionomer is preferably part of a mixture comprising the ionomer and the non-aqueous solvent. However, in some instances, the ionomer (e.g., Nafion®) is supplied as a suspension in water or water/alcohol mixture. This suspension of ionomer can be distilled under vacuum in the presence of the non-aqueous solvent to produce a solution/suspension of ionomer in the non-aqueous solvent(s). The catalyst is then added to the mixture of ionomer and non-aqueous solvent(s) to form the catalyst ink.

The invention also includes a process for making a catalyst coated membrane. A polymer electrolyte membrane (PEM) is first dried at a temperature between 50° C. and 170° C. to form a dehydrated membrane. The membrane is then exposed to air having a temperature between 15° C. and 30° C. and a relative humidity between 35% and 70%. This forms a pretreated membrane.

The catalyst ink is applied to a first surface of the pretreated membrane to form a first catalyst layer. The first surface of the PEM is then contacted with a gas stream having a temperature between 15° C. and 30° C. and a relative humidity of between 35% and 70% to remove bulk fluid from the membrane. Finally, the membrane is dried at a temperature between 50° C. and 170° C. If necessary, the process may be repeated to apply additional layers of catalyst to the PEM to form a catalyst coated membrane (CCM).

In a preferred embodiment, the CCM is annealed at a temperature between 70° C. and 200° C. Pressure may also be applied, e.g, between 1 to 200 kilograms per cm². Temperature and pressure may be applied by use of a hot press or heated rollers

In a preferred embodiment, the PEM is a continuous web and the process is carried out either step wise or on a continuous basis.

The catalyst coated membranes (CCMs) made according to the process of the invention can be used to make membrane electrode assemblies (MEAs) which can be used to fabricate fuel cells such as hydrogen and methanol fuel cells.

### BRIEF DESCRIPTION OF THE DRAWING

FIG. 1 is a flow chart for an embodiment of the process for making a catalyst coated membrane.

FIG. 2 is a plot voltage versus current density for the catalyst coated membrane of Example 1 at various concentrations of methanol.

FIG. 3 is a voltage versus current density plot for a Nafion® membrane which has been coated with the anode and catalyst inks and in the same manner as set forth in Example 1.

### DETAILED DESCRIPTION OF PREFERRED EMBODIMENTS

The invention includes catalyst inks containing metal catalysts, ionomer and one or more non-aqueous solvent(s). The non-aqueous solvent(s) taken together if more than one is present are preferably between 50 to 100 wt % of the liquid present in the catalyst ink, more preferably between 75 and 100 wt %, and still more preferably between 90 and 100 wt %. In some embodiments, the amount of non-aqueous solvent may be slightly less than 100 wt % wherein said solvent is present at between 90 and 99 wt %, more preferably between 95 and 98 wt %. Under such circumstances, the preferred other liquid component is water.

In general, the non-aqueous solvents taken together with any other component in the liquid portion of the catalyst ink will have a dielectric constant of approximately 5 or greater, more preferably 15 or greater and most preferably 30 or greater. Individual non-aqueous solvents also preferably have the aforementioned dielectric constants. However, some non-aqueous solvents may have a dielectric constant which is less than the preferred dielectric constant. However, when combined with one or more other non-aqueous solvents the resultant liquid will have the preferred dielectric constant.

The non-aqueous solvent(s) may be alcohols, glycols, alkyl ethers, alkyl ketones, alkyl esters, alkyl amides, alkyl sulfones, alkyl sulfoxides and alkyl carbonates. The alkyl groups may be linear, branched or cyclic and may be substituted alkyl. Such alkyl groups generally have between 1 and 10 carbon atoms. The non-aqueous solvent(s) generally has a boiling point between 80 and 250° C.

In preferred embodiments, the non-aqueous solvent is dimethylformamide (DMF), N-methylpyrrolidone, propylene carbonate, dimethyl sulfoxide, tetramethylene sulfone, cyclohexanone, cyclopentanone, 2-butoxy ethanol, 2-methoxy ethanol, ethylene glycol, 1,2 propanediol, isopropyl alcohol, glycerol, 1-octanol, butanol, 2-methoxyethyl ether, and/or methyl propyl ketone. A particularly preferred non-aqueous solvent is DMAc.

DMAc may be combined with one or more of the following: N-methyl pyrrolidone, propylene carbonate, dimethyl sulfoxide, tetramethylene sulfone, cyclohexanone, cyclopentanone, 2-butoxy ethanol, 2-methoxy ethanol, ethylene glycol, 1,2 propanediol, isopropyl alcohol, glycerol, 1-octanol, butanol, 2-methoxyethyl ether, and/or methyl propyl ketone.

The non-aqueous solvents preferably have a boiling point of 80° C. to 250° C., more preferably 125° C. to 225° C., and still more preferably between 150° C. and 200° C.

Generally, the non-aqueous solvent is capable of solubilizing the polymer electrolyte membrane (PEM) to which it is applied. This property allows for a plasticizing effect at the surface of the membrane which facilitates bonding between the components of the catalyst layer and the membrane surface. The exposure time between the PEM and the non-aqueous solvent is chosen so as to maximize the strength of the junction between the catalyst layer and the PEM while minimizing the actual solubilization of the membrane during the formation of a catalyst layer.

In general, the amount of ionomer present in the catalyst layers formed from the catalyst ink will be a percentage defined as the mass of the ionomer divided by the mass of ionomer plus the mass of metal catalyst and the mass of the support particles when a supported catalyst is used. These are essentially the solids which will be deposited as the catalyst layer. When supported metal catalysts are used, e.g., platinum Black or platinum/ruthenium Black, it is preferred that the ionomer constitute 1-40%, more preferably between 2 and 25% and most preferably between 4 and 15%. In the case of supported catalyst, it is preferred that the ionomer be between 3 and 90%, more preferably between 5 and 60% and most preferably between 15 and 40%.

Cathode and anode inks may contain different catalysts. For example, in a PEM for a DMFC application it is preferred that the cathode contain Pt as catalyst while the anode contain Pt/Ru as catalyst. In hydrogen fuel cells the preferred catalyst is Pt which is used at both the cathode and anode.

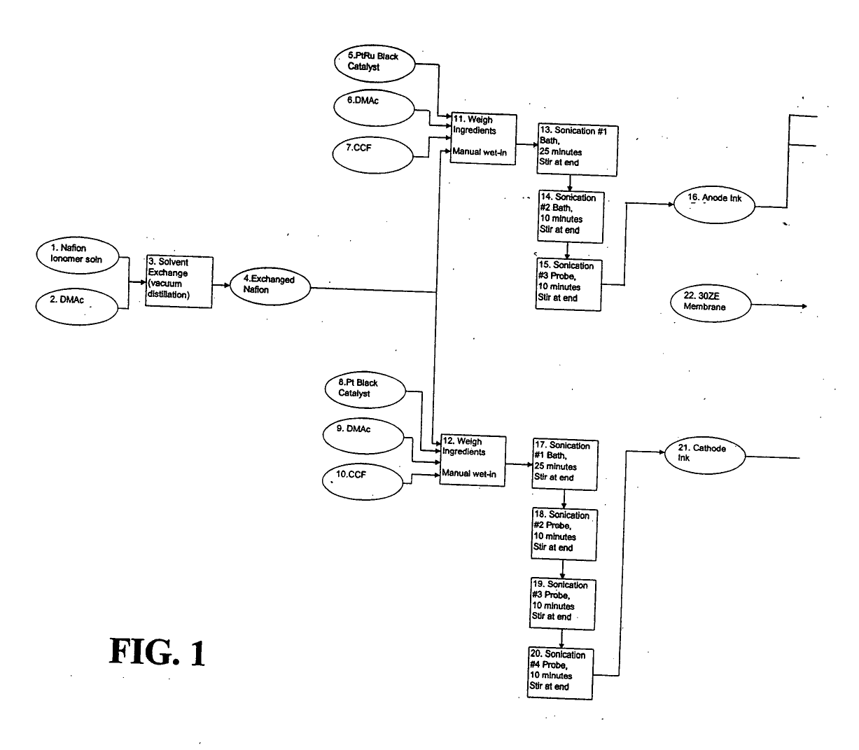

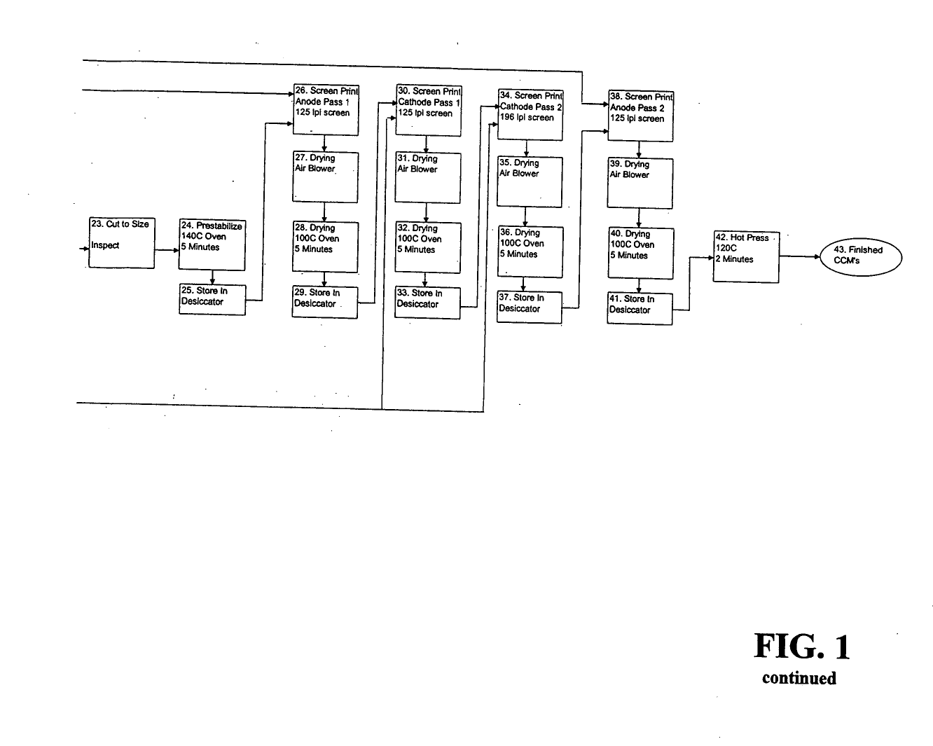

It is preferred that the ionomer and non-aqueous solvent(s) be combined prior to adding catalyst and other components. In some applications Nafion® may be the ionomer of choice. Commercially available Nafion® ionomer is available as a suspension in water/alcohol. In a preferred embodiment, vacuum distillation is used for solvent exchange. See Items 1-4 of FIG. 1. For example, if it is desired to obtain Nafion® at 10% by weight in DMAc, a 5% Nafion® solution in alcohol and water is mixed with DMAc solvent and distilled in a vacuum until the liquid reaches 10% solids. The solution temperature is kept under 55° C., preferably under 40° C. to avoid gelation. This results in a solvent with less than 1% water or alcohol in the mixture.

Ionomers other than Nafion® may be used. Particular ionomers are those having the same or similar formula to the polymer electrolyte membrane used to make the catalyst coated membrane. Use of compositions of the same or similar formula enhances the interface between the catalyst layer and the membrane. In addition, less stress is produced at the catalyst membrane interface when exposed to fuels such as methanol or solvents such as water, since the ionomer and membrane have substantially the same properties such as fuel permeability and swelling caused by water. The overall effect of matching such properties is enhanced durability and a decreased interfacial resistance produced at the catalyst layer/membrane junction as compared to when Nafion® ionomer is applied as a catalyst layer to a membrane which is other than a Nafion® membrane.

The following specifically refers to DMAc and Nafion® ionomer. However, it is to be understood that other non-aqueous solvents and ionomers may be used. An anode catalyst ink can be made by mixing a platinum/ruthenium black catalyst (50/50 atomic ratio) with the above described Nafion® solution where additional DMAc is added as necessary. See Items 5-6 of FIG. 1. In this embodiment, an additional conductive filler is added to the formula to enhance the stability of the ink dispersion, modify the ink viscosity and facilitate electrical conductivity of the catalyst layer. Graphitized synthetic carbon particles with a surface area between 5 and 15 square meters per gram and a particle diameter between 5 and 15 micron diameter are preferred (Asbury Carbons, Asbury, N.J.). The amount of carbon additive may range from 0 to 40% by weight, preferably 3 to 20%. See Item 2 of FIG. 1. Non-graphitized carbon particles may also be used.

A preferred formulation for an anode ink is shown in Table I:

TABLE I

| | wt % |
|---|---|
| PtRu black catalyst | 47.6% |
| 10.0% Nafion/DMAC solution | 43.5% |
| graphitic particles | 2.4% |
| Additional DMAc | 6.5% |
| Total | 100.0% |
| Solids | 54.4% |

Similarly, a cathode ink may be prepared as described above using platinum black catalyst rather than platinum/ruthenium black catalyst (see, e.g., Items 8, 9 and 10 of FIG. 1). A preferred formulation for a catalyst is shown in Table II:

TABLE II

| | wt % |
|---|---|
| Pt black catalyst | 43.4% |
| 10.0% Nafion/DMAC solution | 50.6% |
| CCF (graphitic particles) | 2.2% |
| Additional DMAc | 3.9% |
| Total | 100.0% |
| Solids | 50.6% |

Each of the catalyst inks are separately mixed by repeated sonications (see, e.g., Items 13-15 and 17-20 of FIG. 1). For production runs, more scaleable processes, such as ball milling are preferred over sonication.

The quality of the dispersion may be assessed through the use of a “fineness of grind,” commonly called Hegman gage in the ink making industry. A reading of 1.5 μm or less is acceptable for the inks though a reading of less than 12 μm is preferred.

Anode ink 16 and cathode ink 21 are thereafter used to form a catalyst layer on membrane 22.

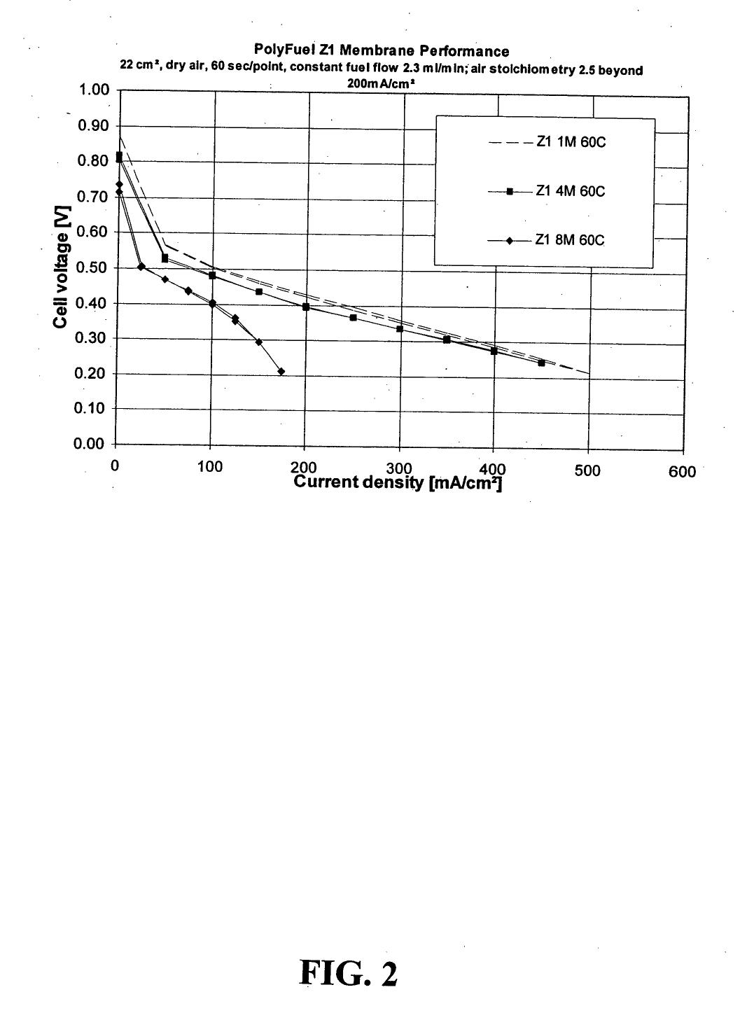

The membrane 22 in FIG. 2 may be any of a wide variety of membranes including those disclosed in U.S. patent application Ser. No. 09/872,770, filed Jun. 1, 2001, Publication No. US 2002-0127454 A1, dated Sep. 12, 2002, entitled “Polymer Composition”; Ser. No. 10/351,257, filed Jan. 23, 2003, Publication No. US 2003-0219640 A1, dated Nov. 27, 2003, entitled “Acid Base Proton Conducting Polymer Blend Membrane”; Ser. No. 10/438,186, filed May 13, 2003, Publication No. US 2004-0039148 A1, dated Feb. 26, 2004, entitled “Sulfonated Copolymer”; Ser. No. 10/449,299, filed Feb. 20, 2003, Publication No. US 2003-0208038 A1, dated Nov. 6, 2003, entitled “Ion Conductive Copolymer”; and 60/520,266, filed Nov. 13, 2003, entitled “Ion Conductive Copolymers Containing First and Second Hydrophobic Oligomers,” each of which are expressly incorporated herein by reference. The process may also be practiced on other membranes commonly known to those skilled in the art. For example, sulfonated trifluorostyrenes (U.S. Pat. No. 5,773,480), acid-base polymers, (U.S. Pat. No. 6,300,381), poly arylene ether sulfones (U.S. Patent Application No. US2002/0091225A1); graft polystyrene (Macromolecules 35:1348 (2002)); and polyimides (U.S. Pat. No. 6,586,561 and J. Membr. Sci. 160:127 (1999)) can be used to make polymer electrolyte membranes which find use in the processes of the present invention. Other membranes include those disclosed in Japanese Patent Application Nos. JP2003147076 and JP2003055457. In addition, as discussed supra, such polymer compositions can be used to formulate ionomers which may be used in the catalyst inks disclosed herein. Although it is preferred that the ionomer correspond to the polymer electrolyte membrane, in some instances, it may appropriate to use ionomers made from any of the above identified formulations for use in catalyst inks applied to polymer electrolyte membranes having a different formula.

Although the following describes a step wise process involving individual membrane sheets, the overall process may be readily converted to a process using a continuous web membrane.

In one embodiment, the overall process for applying a first catalyst layer to a first surface of membrane 22 involves the following steps: (1) Applying heat to dehydrate the membrane (FIG. 1, Item 24); (2) applying the catalyst ink (FIG. 1, Item 26); (3) contacting the first surface of the membrane with a gas stream to remove fluid from the membrane (FIG. 1, Item 27), and (4) drying the membrane (FIG. 1, Item 28). The process may then be repeated on a second surface of the membrane to apply a first catalyst layer to thereby form a catalyst coated membrane. See FIG. 1, Items 30, 31 and 32.

In some embodiments, multiple catalyst layers are applied to the polymer electrolyte membrane. This may be achieved by repeating the aforementioned processes until the catalyst coated membrane has the desired properties. See FIG. 1, Items 34-36 and 38-40

In a particularly preferred embodiment, an additional step is used in the preparation of the catalyst coated membrane. Prior to the application of catalyst ink, the dried membrane is contacted with a gaseous fluid such as air which is maintained at a predetermined temperature and relative humidity. The overall process includes the steps of (1) drying the polymer electrolyte membrane to between 50° C. and 170° C. to form a dehydrated membrane; (2) contacting the dehydrated membrane with a gas such as air having a temperature between 15° C. and 30° C. and a relative humidity between 35% and 70% to form a pretreated membrane; (3) contacting a first surface of said pretreated membrane with the catalyst ink of claim 1 to form a first catalyst layer on said first surface of said PEM; (4) contacting the first surface of the membrane with a gas stream having a temperature between 15° C. and 30° C. and a relative humidity of between 35% and 70% to remove bulk fluid from said membrane, and (5) drying the membrane at a temperature between 50° C. and 170° C.

In each of the aforementioned processes, the drying of the membrane in step 1 is preferably carried out at between 50° C. and 170° C., preferably between 100° C. and 170° C. and most preferably at about 140° C. The drying time depends on temperature but will generally be between 2 and 15 minutes. For example, when drying at 140° C. the drying step should take between 3 and 8 minutes, most preferably 5 minutes. This results in the drying of the membrane. When not dehydrated, CCMs made from such membranes often fracture. In addition, dehydration protects the membrane from aggressive solubilization by the solvent.

In each of the aforementioned processes, the drying of the catalyst coated membrane in the last step of the processes is preferably carried out at between 50° C. and 170° C., preferably between 80° C. and 140° C. and most preferably at about 100° C. The drying time depends on temperature but will generally be between 3 and 30 minutes. For example, when drying at 100° C. the drying step should take between 3 and 10 minutes, most preferably 5 minutes. This results in the drying of the membrane. When not dehydrated, CCMs made from such membranes often fracture. In addition, dehydration protects the membrane from aggressive solubilization by the solvent.

In some embodiments, the polymer electrolyte membrane may be a continuous web on which the catalyst layers may be applied in a step wise or continuous process. Alternatively, the catalyst layers are applied to individual sections of the membrane. In either case, if there is a substantial delay between the drying of the polymer electrolyte or the drying of a membrane because it has been partially coated with catalyst layer(s), the membrane is preferably stored at a temperature between 15° C. and 30° C. and at a relative humidity between 0 and 30%. See, e.g., Items 25, 29, 33 and 37 of FIG. 1. In addition, the CCM may be stored under similar conditions prior to subsequent treatment. See Item 41 of FIG. 1.

After application of the catalyst coated layers, the CCM is preferably annealing at a temperature between about 70° C. and 200° C., more preferably from 90° C.-160° C., and most preferably between 100° C. and 140° C. Pressure may also be applied to the opposing surfaces of the CCM. For example, subjected to a hot press process (see FIG. 1, Item 42) may be used to produce the finished catalyst coated membrane (see FIG. 1, Item 43). A particularly preferred hot press process includes the application of a pressure of about 20 kilograms per square centimeter at 120° C. for 2 minutes. However, these parameters may vary depending upon the components used. Accordingly, pressures may vary from between 1 to 200 kilograms per square centimeter, more preferably between 5 and 50, and most preferably between 10 and 25 kilograms per centimeter squared. The time of the hot press process may range from 1 second to 60 minutes, more preferably from 30 seconds to 30 minutes, and most preferably between 90 seconds to 10 minutes. Alternatively, hot rollers may be used alone or in combination with hot press to apply the necessary temperature and pressure to complete the annealing of the CCM.

The aforementioned catalyst coated membranes are used to make MEAs by combining the CCM with gas diffusion layers and optionally current collectors. While standard gas diffusion layers may be used, gas diffusion layers such as those disclosed in U.S. Patent Application Ser. No. 60/502,024, filed Sep. 10, 2003, entitled “Process for Application of Gas Diffusion Layer to a Catalyst Coated Membrane” can be utilized.

The MEAs are used in fuel cells for portable or stationary applications. Portable uses include electronic devices such as portable computers, video cameras, and vehicles such as automobiles, planes, boats, aerospace vehicles, etc. Stationary applications include residential and commercial power supplies.

### EXAMPLE 1

An anode ink and a cathode ink were produced by mixing together the materials as stated in the table below:

| | Anode | Cathode |
|---|---|---|
| Catalyst Ink Constituents | Ink | Ink |
| PtRu Black Catalyst | 4.0 g | — |
| Pt Black Catalyst | — | 4.0 g |
| Conductive carbon filler | 0.20 g | 0.20 g |
| Nafion solids (in 10.1% solution with DMAc) | 0.366 g | 0.467 g |
| Total DMAc | 3.83 g | 4.55 g |

The Nafion® solution was prepared by taking 200 mg of a stock 5% Nafion® solution, adding 300 mg of DMAc solvent, and distilling under vacuum until the bottom product reached a nominal 10% solids (actual 10.1%). The anode ink was dispersed by mixing with a small spatula for 1 minute, immersing in a bath sonicator for 25 minutes, stirring by hand, sonicating in a bath for another 10 minutes, stirring, then probe sonicating for ten minutes.

The cathode ink was also mixed by hand with a small spatula for approximately one minute before immersing the container in a bath sonicator for 25 minutes. Afterwards, it was stirred again with the spatula, then probe sonicated for three 10-minute cycles, with stirring after each cycle.

The inks were then allowed to rest overnight before using. Inspecting the inks after resting showed that both inks had achieved a “Hegman” score of less than 0.5 mil (0.005 inch). Pieces of a Z1 membrane were made according to U.S. Patent Publication No. US 2004-0039148 A1, dated Feb. 26, 2004, incorporated herein by reference, and in particular to the membrane made according to Examples 7, 8 or 9 therein. These protocols were modified, if necessary, to adjust the sulfonation degree to 30%. The Z1 membrane and Nafion® 117 membrane were prepared by baking in an oven for 5 minutes at 140° C., then storing in a desiccator filled with fresh “Drierite” (calcium sulfate) dessicant. Screens were obtained for printing 22 cm² square blocks using Saatilene® HiTech™ mesh with mesh counts of 125/inch and 196/inch.

Inks were applied by manual screen printing to each membrane piece in the order listed below:

| Catalyst Layer | Catalyst Ink | Screen |
|---|---|---|
| First Anode Layer | Anode | 125 |
| First Cathode Layer | Cathode | 125 |
| Second Cathode Layer | Cathode | 196 |
| Second Anode Layer | Anode | 125 |

Immediately after ink application, the samples were dried under an unheated blower until visually dry (approx. 2.5 minutes), then placed in a 100° C. oven for five minutes, and finally stored in a desiccator in this dried state until the next ink layer was applied. During this time, the room environment was maintained at a temperature of between 71-75° C., with relative humidity at 55-60%. After the final layer was applied and dried, the samples were hot-pressed in a Carver two-post press at a pressure of 20 kg/cm² active area at 120° C. for two minutes.

The samples were then soaked in room temperature deionized water overnight before assembling into fuel cell testing hardware (Fuel Cell Technologies). The assembly was as follows:

Anode gasket: 10 mil PTFE by 22.4 cm² die+1.5 mil Mylar by 21.4 cm² die

Anode GDL: 10BA cut by 22.4 cm2 die

Cathode gasket: 6 mil PTFE by 22.4 die+1.5 mil Mylar by 21.4 cm2 die

Cathode GDL: 20BC cut by 22.4 cm2 die

Following assembly, initial break-in of the sample took place as follows:
(1) H₂/air: 60° C. cell, 65° C. anode humidifier at (200) sccm hydrogen, 55° C. cathode humidifier at (400) sccm air, operating with a load of 0.6V, for three hours
(2) MeOH/air: 60° C. cell, 4.6 mL/min MeOH solution (1 Molar in DI water), 380 sccm air humidified to 55° C. dewpoint in the cathode, 60° C. cathode line heater, with a load of 0.4V for 16 hours.

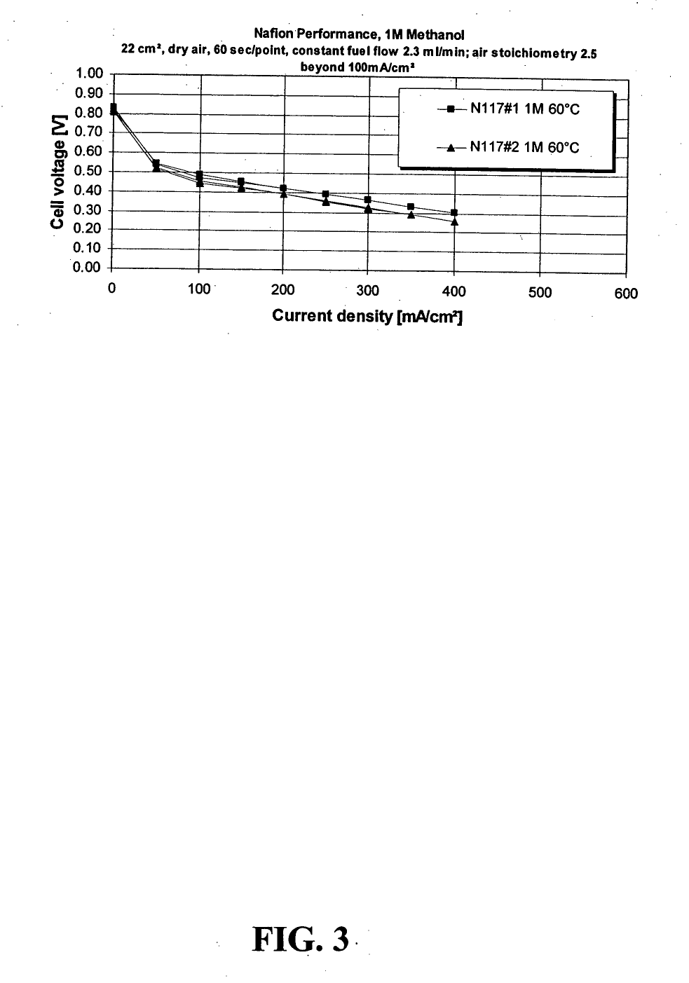

After break-in, the cell was allowed to rest at open circuit for two hours while maintaining temperature at 60 C. Following this, cell performance evaluations were started. The data obtained with 1M, 4M and 8M methanol at 60 C for the Z1 membrane are set forth in FIG. 2. The data for the Nafion® membrane at 60° C. and 1M methanol are set forth in FIG. 3.

What is claimed is:

1. A catalyst ink comprising a metal catalyst, an ionomer and one or more non-aqueous solvents which comprise at least 50 wt % of the liquid in said catalyst ink.

2. The catalyst of claim 1 wherein said one or more non-aqueous solvent(s) when combined have a dielectric constant greater than 5.

3. The catalyst ink of claim 1 wherein said non-aqueous solvent(s) is selected from the group consisting of alcohols, glycols, alkyl ethers, alkyl ketones, alkyl esters, alkyl amides, alkyl sulfones, alkyl sulfoxides and alkyl carbonates, wherein said non-aqueous solvent(s) has a dielectric constant greater than 5.

4. The catalyst ink of claim 1 wherein said non-aqueous solvent(s) is selected from the group consisting of dimethylacetamide (DMAc), dimethylformamide (DMF), N-methylpyrrolidone, propylene carbonate, dimethyl sulfoxide, tetramethylene sulfone, cyclohexanone, cyclopentanone, 2-butoxy ethanol, 2-methoxy ethanol, ethylene glycol, 1,2 propanediol, isopropyl alcohol, glycerol, 1-octanol, butanol, 2-methoxyethyl ether, and/or methyl propyl ketone.

5. The catalyst ink of claim 1 wherein said non-aqueous solvent is DMAc.

6. The catalyst ink of claim 1 wherein said non-aqueous solvent(s) is greater than 95 wt % of the liquid in said catalyst ink.

7. The catalyst ink of claim 1 further comprising a conductive filler.

8. The catalyst ink of claim 7 wherein said conductive filler comprises graphite particles, carbon particles or graphitized carbon particles.

9. A method for making a catalyst ink comprising mixing an ionomer, metal catalyst and one or more non-aqueous solvents to form a catalytic ink, wherein said non-aqueous solvent(s) is at least 50 wt % of the liquid portion of said catalyst ink.

10. A method for making a catalyst ink comprising
contacting an aqueous medium comprising an ionomer with one or more non-aqueous solvents to replace all or part of said aqueous medium with said non-aqueous solvent(s) whereby a mixture of ionomer in said non-aqueous solvent is formed, and
combining said mixture with a metal catalyst to form said catalyst ink, wherein the total of said non-aqueous solvent(s) is at least 50 wt % of the liquid portion of said catalyst ink.

11. A catalyst ink made according to the method of claim 9.

12. A method for making a catalyst coated membrane comprising:
(a) drying a polymer electrolyte membrane (PEM) at a temperature between 50° C. and 170° C. to form a dehydrated membrane,
(b) contacting said dehydrated PEM with a gas having a temperature between 15° C. and 30° C. and a relative humidity between 35% and 70% to form a pretreated membrane,
(c) contacting a first surface of said pretreated PEM with the catalyst ink of claim 1 to form a first catalyst layer on said first surface of said PEM,
(d) contacting said first surface of said PEM with a gas stream having a temperature between 15° C. and 30° C. and a relative humidity of between 35% and 70% to remove bulk fluid from said membrane, and
(e) drying said membrane at a temperature between 50° C. and 170° C.

13. The method of claim 12 wherein said steps (b) through (e) are repeated with the same or a different catalyst ink to apply a first catalyst layer on a second surface of said PEM.

14. The method of claim 13 wherein steps (b) through (e) are repeated to apply one or more additional layers of catalyst to said first surface of said PEM.

15. The method of claim 14 wherein said steps (b) through (e) of claim 10 are repeated to apply one or more additional layers of catalyst on said second surface of said PEM.

16. The method of claims 12 further comprising annealing said catalyst layer(s) at a temperature between 70 and 200° C.

17. The method of claim 16 further comprising the application of pressure to said first and said second surfaces, said pressure being between 1 to 200 kilograms per centimeter squared.

18. The method of claim 16 wherein said all or part of said pressure and said temperature is applied by a hot press or heated rollers.

19. The method of claims 12 wherein said PEM is a continuous web.

20. A method of making a catalyst coated membrane comprising:
applying the catalyst ink of claim 1 to a first surface of a polymer electrolyte membrane (PEM),
drying said PEM,
applying the same or a different catalyst ink to a second surface of said PEM, and
drying said membrane.

21. The method of claim 20 wherein said first and said second catalyst layers are applied simultaneously.

22. A catalyst coated membrane (CCM) made according to the method of claims 12.

23. A membrane electrode assembly (MEA) comprising the catalyst coated membrane of claim 22.

24. A fuel cell comprising the MEA of claim 23.

25. An electronic device comprising the fuel cell of claim 24.

26. A power supply comprising the fuel cell of claim 24.

27. An electric motor comprising the power supply of claim 24.

28. A vehicle comprising the fuel cells of claim 24.
